(19) United States
(12) Patent Application Publication
(10) Pub. No.: US 2019/0269160 A1
(43) Pub. Date: Sep. 5, 2019

(54) DRIED FRESH JUJUBE SLICES AND ENERGY-SAVING PROCESS TECHNOLOGY FOR DIFFERENTIAL PRESSURE EXPANSION DRYING

(71) Applicants: Xihong LI, TIANJIN (CN); NINGXIA ZHONGXI JUJUBE INDUSTRY LIMITED CO., LTD., LINGWU (CN); Tianjin University of Science and Technology, TIANJIN (CN)

(72) Inventors: Xihong LI, TIANJIN (CN); Weiqiao YANG, TIANJIN (CN); Yuzheng ZHANG, TIANJIN (CN); Gang ZHU, TIANJIN (CN)

(73) Assignees: NINGXIA ZHONGXI JUJUBE INDUSTRY LIMITED CO., LTD.; Tianjin University of Science and Technology

(21) Appl. No.: 16/166,120

(22) Filed: Oct. 21, 2018

Related U.S. Application Data
(63) Continuation of application No. PCT/CN2018/103184, filed on Aug. 30, 2018.

(30) Foreign Application Priority Data
Mar. 2, 2018 (CN) 201810175098.2

(51) Int. Cl. A23L 19/00; A23B 7/045; A23B 7/06; A23L 5/41; A23L 3/015

(52) U.S. Cl. CPC A23L 19/05; A23B 7/045; A23V 2002/00; A23L 5/41; A23L 3/015; A23B 7/06

(57) ABSTRACT

A method for processing dried fresh jujube slices includes the following steps: preparing jujube slices, coring and removing stems, quick-freezing and retaining freshness of the jujube slices, thawing frozen jujube slices, protecting color treatment, expanding jujube slices under differential pressure, preparing superfine mixed seasoning powder, and coating of the superfine mixed seasoning powder. For one hand, this method solves problems that the dried fresh jujube slices will be deeply oxidized and brown when dried by the hot air at a high temperature of 90-110° C., the jujube slices with compacted cells will become harder and be difficult to chew because of 6-8 h rapid dehydration. On the other hand, it solves problems that exist in freeze drying at a vacuum degree of 1.3-13 Pa, and at a low temperature of −10-50° C., such as high energy consumption, long processing cycle, high equipment investment, small size of slices, and poor taste.

### CROSS-REFERENCE TO RELATED APPLICATIONS

This application is a continuation of International Patent Application No. PCT/CN2018/103184 with a filing date of Aug. 30, 2018, designating the United States, now pending, and further claims priority to Chinese Patent Application No. 201810175098.2 with a filing date of Mar. 2, 2018. The content of the aforementioned applications, including any intervening amendments thereto, are incorporated herein by reference.

### TECHNICAL FIELD

The disclosure relates to the technical field of jujube deep processing, and particularly relates to a dried fresh jujube slice and processing method thereof.

BACKGROUND OF THE PRESENT INVENTION

Lingwu long jujube is a kind of fruit type that has big size, green and crispy flesh, sweet and sour taste, unique flavor, and it is especially suitable for direct fresh. However, once picked at the mature stage, it is “2 days for wilting, 3 days for softening and 5 days for rot” at room temperature, and its long preservation duration at low temperature is only 30-40 days. Jujube dried by traditional hot air drying process is wizened and hard texture. Because of the large fruit shape and core, the jujube is neither suitable for whole jujube baking, nor suitable for low temperature freezing drying for texture of product is too soft, crisp but not brittle.

At present, restricting processes for producing fresh jujube slices are described below:

(1) The expansion of fresh jujube slices is different from that of cereal starch expansion. The product of fresh jujube slices relies on the water-vapor phase and transient transboundary expansion changes in volume, which is the basis for the production of dried fresh jujube slices. The moisture content distribution of fresh jujube and its fresh jujube flesh is usually uneven. The fruits at different maturity states of the same tree and even the same result branch are accompanied by symbiosis, their differences are about 10-20 days. When harvesting, the fruits of different maturity are harvested and mixed together. However, the flesh water contents of fresh jujube at different maturity states, or different soil texture, irrigation amount, fertilization level, topography and tree age, pruning method, and even in different parts of the same jujube are greatly different. Therefore, when the fresh jujube slices are dried, due to the different water content, the slice color and the texture are uneven, and this is also the first bottleneck of the dried fresh jujube slices industry.

(2) Fresh jujube is extremely easy to fermentation and rot, and it will become easier to fermentation, brown, soften and rot after corded and slicing for damaging respiration and ethylene, and usually the retaining time at room temperature is only 3-6 hours and that at 0° C. only 24-36 hours. Therefore, the supply of fresh jujube slices is the second biggest bottleneck in the slices industry.

(3) The color of fresh jujube flesh is light green. After the flesh is made into jujube slices, it becomes a common snack with bright color and delicious taste. The jujube is easy to crack when corded and sliced, and needs to be softened. When the jujube cord falls off from the jujube, the jujube is easy to crack. Therefore, an opening with a depth of 1-1.2 cm is drilled on one side of the jujube firstly. Keeping vibrating when the opening is drilled to break the jujube cord and the jujube flesh slightly, and in this way jujube is not easy to crack. The jujube cord is an olive-shaped structure with two thin ends and thick tip in the middle and easy to crack when opening.

After searching, it was found that the patent documents related to the present application disclose the following contents:

(1) Chinese Patent Application No. CN201610139395 discloses dried fruit and vegetable slices with chocolate coating and preparation method thereof. In this disclosure, the fruits and vegetables are expanded by adopting freeze drying pretreatment and vacuum microwave expansion technology. The method is fast and efficient, but the production cost is relatively high, and the coating is thicker, which affects the taste.

(2) Chinese Patent Application No. CN201710441457X discloses a method for processing radish slices. The method provided in this disclosure is firstly pickle and then vacuum freeze drying. The freeze drying is performed at a temperature gradient rising from −45° C. to −25° C. The drying process is cumbersome and the operation is not convenient to control.

(3) Chinese Patent Application No. CN2013103022332 discloses differential pressure expansion method for processing apple slices. This disclosure adopts a differential pressure expansion method to processing apple slices, and the differential pressure is 0.3-0.4 MPa which is relatively high and may cause broken of products.

In combination with above patents and related part in the present disclosure, defects in the prior art are as follows:

1. Brittleness and color of Lingwu long jujube slices are important indexes for judging product quality. Unsuited pretreatment will result in incomplete shape of slices, dim color and low product quality. The performance of freeze-thaw treatment before the expansion treatment stage can maintain the brittleness and integrity of the product.

2. Pectin content in hawthorn powder is high, which leads to agglomeration and poor solubility of powder, further affects the taste; tannin content in hawthorn powder is also high, resulting in bitter taste.

3. Too high pressure easily results in cracking of slices, and with the assistance of ultrasonic can effectively reduce the expansion pressure. The pressure control in a variable temperature and differential pressure expansion technology is the key technology of the whole expansion process. The higher the pressure is, the greater the differential pressure between a pressure tank and a vacuum tank is, and the more obvious the expansion effects are. However, if the pressure is too high, the jujube slices will be expanded and cracked excessively, which will destroy the appearance; if the pressure is too low, the expansion effect will be not obvious.

4. Excessive temperature in variable temperature and differential pressure expansion will lead to the happening of Maillard browning reaction in the internal amino acids and reducing sugars, resulting in uneven color of the product and weakened taste.

### SUMMARY OF PRESENT INVENTION

The object of the disclosure is to overcome defects in prior art and provide a method for processing dried fresh jujube slices with crispy taste, pleasant color and rich nutrition.

The object is realized by following technical solutions:

A method for processing dried fresh jujube slices, comprises the followings steps:

1) preparing jujube slices by washing and classify fresh jujubes, performing anti-cracking treatment to the jujubes, and blanching the jujubes at a temperature of 50-60° C. for sterilization;

2) coring and removing stems by cutting off both ends of the jujubes, drilling an opening with a depth of 1-1.2 cm at a center of one of the cutting end surfaces formed, when drilling, keeping a driller vibrating at the same time to core, cutting the cored jujubes into slices of 3-5 mm thickness, classifying the slices, and removing irregular slices;

3) quick-freezing and retaining freshness of the jujube slices by quick-freezing fresh jujube slices at a temperature of −40° C. for 2-5 min, and then retaining at a temperature of −18° C. for standby application;

4) thawing frozen fresh jujube slices by spraying frozen jujube slices from two sides thereof with a steam at a temperature of 110° C. and at a pressure of 0.1-0.15 Mpa, wherein the sprayed steam contains 3-5 wt % of phytic acid, and the steam is sprayed onto a surface of the slices for 1-2 min;

5) protecting color treatment by impregnating thawed jujube slices in color protecting solution for 30-50 min, wherein the color protecting solution is adjusted to pH 8 with NaHCO₃ and contains one or more of zinc gluconate, calcium gluconate, zinc oxide, calcium sulfate, and selenium gluconate;

6) expanding jujube slices under differential pressure by turning on an electromagnetic valve to connect a steam generator and an expansion tank, superheated steam transported by the steam generator heating the expansion tank to raise a temperature in the expansion tank being raised to 102-104° C., and turning off the electromagnetic valve; opening an intake valve to connect an air compressor and the expansion tank, introducing non-condensing gas nitrogen to rise a pressure in the expansion tank from 0.1 MPa to 0.6 MPa in 15-20 min, and closing the intake valve; turning on a vacuum pump and vacuuming a vacuum tank to −0.08 MPa; opening a pressure-relief valve to connect the expansion tank and the vacuum tank, which makes raw materials expanding instantaneously, so that a large amount of water in the expansion tank is taken away; introducing cooling water into cooling tubes quickly to lower a temperature in the expansion tank to 90° C. required for vacuum drying; vacuum drying for 220-250 min, assisting with supersonic during vacuum drying process at a supersonic intensity of 500-800 W, when a moisture content in the raw materials being lower than 5%, closing the pressure-relief valve, and stopping vacuuming; and introducing cooling water to lower the temperature to 25-35° C., opening a ventilating valve, taking out products after the pressure return to atmospheric pressure;

7) preparing superfine seasoning powder by mixing uniformly 15-25 parts of hawthorn fruit powder, 35-50 parts of cocoa powder, 10-20 parts of cocoa butter, 15-25 parts of coconut powder, 15-25 parts of jujube powder calculated by total weight, wherein all powders are ultrafine powders with a diameter less than 5-10 μm; and

8) coating of the superfine mixed seasoning powder by spraying the prepared superfine seasoning powder on an outer surface of the expanded jujube slices, and then packaging after completely cooling.

In addition, a method for preparing the hawthorn fruit powder comprises:

pretreating hawthorns by washing the hawthorns, heating and color protecting, beating and sieving, enzymolysis treatment, blending, and spray drying;

first step: adding compound color protecting agent with total mass fraction of 0.05-0.1% into 20-30 parts of corded and stem-removed hawthorns, and boiling in hot water at a temperature of 80-90° C.;

second step: putting preprocessed hawthorns into a beating machine, beating the mixture containing water and hawthorn with a volume ratio of 1:3, sieving the beaten mixture with a sieve, adding Ca(OH)₂ to adjust pH to 3.5-4.0, and obtaining a hawthorn pulp;

third step: enzymolysis by adding 0.1%-0.2% cellulose complex enzyme, 0.05%-0.1% hawthorn pulp enzyme, 0.1%-0.2% pectinase and 0.10%-0.15% tannase to hydrolyze supersonically the hawthorn pulp obtained in the second step for 3 h at a power of 200-300 W and at a temperature of 50-55° C., and then inactivating enzymes;

fourth step: blending the hawthorn pulp in a blender; and

fifth step: spray drying by putting the hawthorn pulp into a centrifugal spray drying tower, an inlet temperature of the centrifugal spray drying tower being 180-185° C., a flowing rate in a peristaltic pump being controlled at 14 r/min, a rotating speed of a nozzle of the centrifugal spray drying tower being 6400-8000 r/min, after the centrifugal spray drying tower is completely cooled, collecting the produced hawthorn powder for standby application.

In compare to the prior art, the advantages and beneficial effects of the present disclosure are as follows:

The disclosure relates to a dried fresh jujube slices and an energy-saving processing technology for differential pressure expansion drying, the technology is particularly suitable for processing the dried fresh jujube slices. For one hand, this technology solves problems that the dried fresh jujube slices will be deeply oxidized and brown when dried by the hot air at a high temperature of 90-110° C., the jujube slices with compacted cells will become harder and be difficult to chew because of 6-8 h rapid dehydration. On the other hand, it solves problems that exist in freeze drying at a vacuum degree of 1.3-13 Pa, and at a low temperature of −10-50° C., such as high energy consumption, long processing cycle, high equipment investment, small size of slices, and poor taste. The dried fresh jujube slices produced by differential pressure expansion drying achieves their best in color, smell, taste, texture, hardness (g) of 456.89, brittleness (N/S) of 2786.23.

The disclosure processes Lingwu long jujube into dried fresh jujube slices by adopting supersonic, quick-freezing, cold water thawing frozen along with color protection treatment, by adjusting synergistic corporation of supersonic at a intensity of 500-800 W and temperature and time that quick-freezing in −40° C., frozen retaining in −18° C., cold water color protection and thawing frozen, realizing a series benefits of five: (1) Quick-freezing treatment of dried fresh jujube slices can maintain the integrity of cell tissue structure, especially avoid the integrity of submicrostructures such as organelles, cell membranes and cell walls being damaged. After being quick-frozen at a temperature of −40° C., the raw material fresh slices are transferred to long-term high-quality preservation at a temperature of −18° C. (2) In order to reduce energy consumption for expansion heating, rising a temperature of slices to 15-18° C. quickly when slices are thawing frozen by cold water before slices stored in −18° C. are expansion dried. By utilizing latent heat of tap water and groundwater, initial temperature of the raw material slices before heating is rose from −18° C. to 15-20° C. by a ground source heat pump. In this way, a temperature difference of 30-40° C. is reduced, so as to achieve effect of saving energy. (3) When thawing frozen by water, supersonic action is supplemented, which damages the submicrostructures of the cells slightly. On the one hand, mass transfer efficiency of differential pressure expansion drying is improved, on the other hand, the problem could be avoided that frozen slices will be oxidized and brown in water with low-oxygen content of 8-9 mg/L, and color, smell, taste of frozen slices will be destroyed. (4) When thawing frozen by water, one or more of following mineral nutrients with low concentration of 0.1%-0.2% could be supplemented as low temperature color protection agents: zinc oxide, zinc sulfate, calcium chloride, calcium sulfate, selenium malt, selenomethionine, Vc, and tea polyphenol, so as to help nutrients evenly penetrating during expansion and drying. (5) The rehydrating method of water thawing frozen makes moisture content of raw material slices 00%-00% uniform, rehydrated slices are dried at high-pressure air with a temperature of 20-30° C. to remove excess water, so that a load of differential pressure expansion drying is reduced more than 10%, parameter data such as differential pressure expansion drying temperature, vacuum degree and time is convenient to standardly adjusted, and a consistency of color, smell, taste and texture quality of slices is further achieved.

Dried fresh jujube slices, which are different from dried jujube slices and common fruit or vegetable slices like apples, pears, cucumbers, etc. Especially Lingwu long jujube, its growth environment is dry, its water content is low, its cell texture is dense, its fruit shape is long and large. Generally speaking, its length is 45-50 mm, transverse diameter is 23-34 mm, single fruit weight is 25-30 g, water content is 45%-55%, sugar content is more than 30%, acid content is more than 0.25%, and it is easy to be roasted into zombie jujube or be oxidized, brown and turn into black jujube during conventional drying.

The present disclosure adopts method of freeze-thaw for many times to preprocess the Lingwu long jujube fresh jujube slices. Freezing can rapidly destroy the cell structure, thereby it is more easily to lost moisture during the thawing process. The better effect will be gain when freeze-thaw for many times, in this way the brittleness and the color of products can be maintained. In addition, dehydration speed will be fast, texture of products will be crispy, the integrity of the cell membrane will be protected, and expansion effect will be ensured.

The present invention adopts non-condensing gas nitrogen to dilute the superheated steam, so that problems like uneven color and browning caused by the superheated steam can be effectively avoided in the heating and pressure raising processes. The present disclosure adopts a new supersonic-assisted differential pressure expansion process, and utilizes cavitation effect of super sonic waves to help micro gas nucleation cavitation bubbles in the liquid rapidly grow and collapse, and the cell wall will be broken, thereby the differential pressure will be reduced. The best expansion effect can be achieved under the condition of small differential pressure. The present disclosure adopts a new supersonic synergistic enzymolysis process to prepare hawthorn powder, and mixes cocoa is used to form a jam coating, which increases acid sweetness of the slices and at the same time prevents the slices from becoming damp and prolongs the shelf life. The steam contains 3-5% phytic acid, the phytic acid can form a film which can help to form pressure when expanding, so as to increase the expansion effect, and spraying onto the surface of the slices is keep for 1-2 min.

The present disclosure adopts the following solution for homogenization: treating jujubes with 20-50 mg/kg ethephon for 10-12 h at room temperature of 15-20° C. immediately after picked, the time is actually equal to an interval between harvest and cleaning, classifying, and cutting process at the next day. While washing jujubes, a supersonic will synergize to make the mass and the water content uniform, which is equivalent to shuffle and re-license. Thaw and rehydrate. The cut slices are quick-freezed immediately in a fluidized bed at a temperature of −40° C. for 3-10 min, and then stored at a low temperature of −18° C. Before expansion, the slices are impregnated in water at a temperature of 18-20° C., along with thawing and rehydrating for 40-60 min. Color protection. When thawing and rehydrating, 0.1%-0.2% of agents are added to treat for 40-60 min, which is selected from at least one of the following compounds: zinc oxide, zinc sulfate, calcium carbonate, calcium chloride and selenium oxide, then rinse slices with water for 2-3 times and directly carry out expansion.

### DESCRIPTION OF THE DRAWINGS

FIG. 1 is a diagram showing comparison between qualities of jujube slices under different pressures.

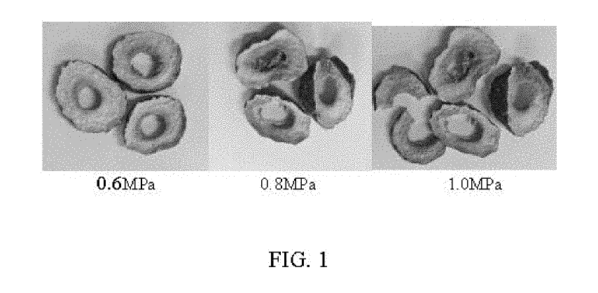

### DETAILED DESCRIPTION OF PREFERRED EMBODIMENTS

The present disclosure will now be further described in details with reference to embodiments. The embodiments below are only illustrative, but not restrictive, and the scope of the disclosure should not be limited to the embodiments described.

A method for processing dried fresh jujube slices, comprises the following steps:

Treatments after picking: treating jujube with 20-50 mg/kg ethephon for 10-12 h at room temperature of 15-20° C. immediately after picked, wherein the time is actually equal to an interval between harvest and cleaning, classifying, and cutting process at the next day. While washing jujubes, a supersonic will synergize to make the mass and the water content uniform, which is equivalent to shuffle and re-license.

1) preparing jujube slices by washing and classify fresh jujubes, performing anti-cracking treatment to the jujubes, and blanching the jujubes at a temperature of 50-60° C. for sterilization, wherein the blanching treatment at the temperature of 50-60° C. can realize the object of sterilization, on the other hand, it can also soften the jujube to prevent damage to the integrity of the jujube during the subsequent coring process;

2) coring and removing stems by cutting off both ends of the jujubes, drilling an opening with a depth of 1-1.2 cm at a center of one of the cutting end surfaces formed, when drilling, keeping a driller vibrating at the same time to core, cutting the cored jujubes into slices of 3-5 mm thickness, classifying the slices, and removing irregular slices, wherein the vibrating during opening can preliminarily separate a jujube core from the jujube flesh to prevent a sudden separation of the jujube core during the coring process and damage the jujube flesh in a large area, so as to effectively improve the yield;

3) quick-freezing and retaining freshness of the jujube slices by quick-freezing fresh jujube slices at a temperature of −40° C. for 2-5 min, and then retaining at a temperature of −18° C. for standby application; wherein the principles of freeze-thawing pretreatment for many times are that water in the tissue of the fruit and vegetable is present in a combined state and a free state, when the temperature is lowered than the freezing point, water that is weakly bound to the hydrophilic colloid or mainly in the intercellular space forms ice crystals firstly, as a result, the concentration of the solution near the ice crystal is increased and an osmotic pressure is formed to drive intracellular juice, and an extrusion will be formed from ice crystals to cells, so that the moisture inside the cells will continuously spread to the outer side of the cell and accumulate around the ice crystals, at the same time, when the water vapor pressure formed by the intracellular juice is greater than that of the ice crystals, these moistures will continuously spread to the outer side of the cells and surround the ice crystals, thus partial dehydration of the cells will be caused, and at the same time, during the freezing process, the cell tissue is further subjected to temperature shock and dehydration is more thorough;

4) thawing frozen fresh jujube slices by spraying frozen jujube slices from two sides thereof with a steam at a temperature of 110° C. and at a pressure of 0.1-0.15 Mpa, wherein the sprayed steam contains 3-5 wt % of phytic acid, and the steam is sprayed onto a surface of the slices for 1-2 min by adopting a fluidized bed continuous spraying, the steam contains 3-5% phytic acid, the phytic acid can form a film which can help to form pressure when expanding, and the internal expanded pores can be increased by about 10% with the rise of the pressure, so that the dried jujube slices taste more brittle;

5) protecting color treatment by impregnating thawed jujube slices in a color protecting solution for 30-50 min, wherein the solution is adjusted to pH 8 with NaHCO₃ and contains one or more of zinc gluconate, calcium gluconate, zinc oxide, calcium sulfate, and selenium gluconate, the concentration of the color protecting solution is 0.05-0.1%, all components of the color protecting solution are nutrients, metal ions have high nutritional value, they can increase the brittleness and further supplement the nutrition of the jujube slices; color of fresh jujube slices are emerald green, and the color is easily discolored after being expanded at a high temperature, so the color protection treatment is performed in a step before the expansion;

6) pretreating hawthorns by washing hawthorns→heating and color protecting→beating and sieving→enzymolysis treatment→blending→spray drying;

first step: adding a compound color protecting agent which contains 0.01-0.05 wt % L-cysteine, 0.05-0.1 wt % phytic acid and 0.05-0.1wt % lemon into 20-30 parts of corded and stem-removed hawthorns, and boiling in hot water at a temperature of 80-90° C.;

second step: putting preprocessed hawthorns into a beating machine, beating a mixture containing water and hawthorn with a volume ratio of 1:3, sieving the beaten mixture with a sieve, adding Ca(OH)₂ to adjust pH to 3.5-4.0, and obtaining a hawthorn pulp;

third step: enzymolysis by adding 0.1%-0.2% cellulose complex enzyme, 0.05%-0.1% hawthorn pulp enzyme, 0.1%-0.2% pectinase and 0.10%-0.15% tannase to hydrolyze supersonically the hawthorn pulp obtained in the second step for 3 h at a power of 200-300 W and at a temperature of 50-55° C.; wherein under the action of tannase, the ester bond, phenolic bond and glycosidic bond in the tannin molecule of hawthorn are broken and catalyzed to form the corresponding depsipeptide and polyol, and they will continue to be degraded into phloroglucinol and resorcinol under the action of enzymes, and finally are degraded into small molecular substances such as 3-hydroxy-5-oxo-hexanoic acid and 5-oxo-6-hexanoic acid methyl ester, thus the bitterness is reduced;

fourth step: blending, blending the hawthorn pulp in a blender; and

fifth step: spray drying by putting the hawthorn pulp into a centrifugal spray drying tower, an inlet temperature of the centrifugal spray drying tower being 180-185° C., a flowing rate in a peristaltic pump being controlled at 14 r/min, a rotating speed of a nozzle of the centrifugal spray drying tower being 6400-8000 r/min, after the centrifugal spray drying tower is completely cooled, collecting the produced hawthorn powder for standby application;

7) expanding jujube slices under differential pressure by turning on an electromagnetic valve to connect a steam generator and an expansion tank, superheated steam generated by the steam generator heating the expansion tank to raise a temperature in the expansion tank to 102-104° C., and turning off the electromagnetic valve; opening an intake valve to connect an air compressor and the expansion tank, introducing non-condensing gas nitrogen to raise a pressure in the expansion tank from 0.1 MPa to 0.6 MPa in 15-20 min, and closing the intake valve; turning on a vacuum pump and vacuuming a vacuum tank to −0.08 MPa; opening a pressure-relief valve to connect the expansion tank and the vacuum tank, which makes raw materials expanding instantaneously, so that a large amount of water in the expansion tank is taken away; introducing cooling water into cooling tubes quickly to lower a temperature in the expansion tank to 90° C. required for vacuum drying; vacuum drying for 220-250 min, assisting with supersonic during vacuum drying process at a supersonic intensity of 500-800 W, when a moisture content in the raw materials being lower than 5%, closing the pressure-relief valve and stopping vacuuming; and introducing cooling water to lower temperature to 25-35° C., opening a ventilating valve, taking out products after the pressure return to atmospheric pressure; and

8) preparing superfine seasoning powder by mixing uniformly 15-25 parts of hawthorn fruit powder, 35-50 parts of cocoa powder, 10-20 parts of cocoa butter, 15-25 parts of coconut powder, 15-25 parts of jujube powder,wherein all powders are ultrafine powder with a diameter less than 5-10 μm; and

9) coating of the superfine mixed seasoning powder by spraying the prepared superfine seasoning powder on an outer surface of the expanded jujube slices, and then packaging after completely cooling.

By adopting the method of the present disclosure, a porosity of the jujube slices is increased by 20%, an internal color of the fresh jujube is pale green, and the ultrafine powder is sprayed on the outside of the jujube slices, and the taste of the jujube slices is crispy and changeable, the jujube slices is a new type of snack food with good taste and rich nutrition that has never appeared temporarily in the market.

The relevant parameters and results of the test for jujube skin are described below.

TABLE 1
Effect of expansion temperature on the quality of expanded slices

| Expansion | | | |
|---|---|---|---|
| temperature (° C.) | Moisture (%) | Hardness (g) | Brittleness (N/S) |
| 70 | 32.76 | 1231.01 | 120.23 |
| 80 | 18.51 | 1836.56 | 252.01 |
| 90 | 7.36 | 2798.32 | 425.12 |
| 100 | 5.11 | 2786.23 | 456.89 |
| 110 | 4.89 | 2741.89 | 445.23 |

TABLE 2
Effect of vacuum temperature on the quality of expanded slices

| Vacuuming | | | |
|---|---|---|---|
| temperature (° C.) | Moisture (%) | Hardness (g) | Brittleness (N/S) |
| 60 | 27.76 | 1331.01 | 132.83 |
| 70 | 23.51 | 1936.56 | 272.01 |
| 80 | 7.36 | 2898.32 | 417.12 |
| 90 | 5.52 | 2786.23 | 442.80 |
| 100 | 5.13 | 2748.89 | 435.23 |

With the increase of vacuum temperature, the moisture content of the slices is significantly reduced, while the hardness and brittleness are significantly increased. When the temperature is above 90° C., the moisture content changes slowly, and the moisture content, hardness and brittleness of the product are good. Considering comprehensively, the vacuum temperature is preferably 90° C.

TABLE 3
Effect of vacuuming time on the quality of expanded slices

| Vacuuming | | | |
|---|---|---|---|
| time (min) | Moisture (%) | Hardness (g) | Brittleness (N/S) |
| 150 | 29.26 | 1446.81 | 142.23 |
| 180 | 9.51 | 2896.56 | 476.01 |
| 210 | 5.16 | 2998.32 | 455.12 |
| 240 | 4.98 | 4286.73 | 556.89 |
| 270 | 4.77 | 4848.19 | 545.23 |

With the extension of the vacuuming time, the moisture content of the slices is significantly reduced. However, when the moisture content is reduced to a certain extent, it is difficult to transfer the water again, so there is no significant difference between the products with a vacuum time more than 240 min, and the moisture content has already been lower than 7%; the hardness and the brittleness are increase sharply between 210-240 min, and the change was not obvious after 240 min. Considering comprehensively, the vacuuming time is preferably 240 minutes.

TABLE 4
Effect of differential pressure on the quality of puffed slices

| Differential | | | |
|---|---|---|---|
| pressure (MPa) | Moisture (%) | Hardness (g) | Brittleness (N/S) |
| 0.2 | 5.76 | 2853.01 | 410.23 |
| 0.4 | 5.51 | 2836.56 | 452.01 |
| 0.6 | 4.96 | 3798.32 | 525.12 |
| 0.8 | 4.53 | 3886.23 | 556.89 |
| 1.0 | 4.21 | 3941.89 | 623.23 |

There is no significant difference in moisture content, hardness and brittleness between the treatments of 0.2-0.4 MPa, and these sense scores are higher. There is no significant difference in moisture content, hardness and brittleness between the treatments of 0.8-1.0 MP, but the differential pressures are too large, causing the slice to crack and the sense quality to drop. Considering comprehensively, the expansion pressure of 0.6 MPa should be selected.

TABLE 5
Comparison of the color of different drying methods

| Drying method | L | a* | b* |
|---|---|---|---|
| AD | 52.18 | 12.36 | 19.63 |
| FD | 82.35 | 5.36 | 27.89 |
| EFD | 69.32 | 8.32 | 22.36 |

Referring to Table 5, the three drying method values are put in order from high to low, that is, the color is from shallow to deep, freeze drying, expansion drying, and hot air drying. The drying method has a significant effect on the color of the dehydrated jujube slices. The color of the freeze drying samples is the best, and the color of the jujube slices prepared by the differential pressure expansion drying is better than that of hot air drying. This result may be related to a vacuum state of the material. During the freeze drying process, the material is always in a freezing vacuum state. During the expansion drying process, the materials are mostly in a vacuum state, while in the hot air drying process, the materials are in a atmospheric pressure state. Jujube slices are more stable under vacuum state.

The rehydration rate of freeze drying is the best, and the equilibrium is reached after rehydration for 20 min, the variable temperature and differential pressure expansion drying ranks the second. This is because the freeze-dried product and the variable temperature differential pressure expansion drying product have a porous structure; the rehydration rate of hot air drying product is relatively lower. According to the rehydration rate of jujube slices, the solubility and the modulability of the silty products can be predicted. It can be predicted that the freeze-dried jujube powder and the variable temperature differential pressure expansion drying jujube powder have better solubility and adjustability.

We claim:

1. A method for processing dried fresh jujube slices, comprising the following steps:
1) preparing jujube slices by washing and classify fresh jujubes, performing anti-cracking treatment to the jujubes, and blanching the jujubes at a temperature of 50-60° C. for sterilization;
2) coring and removing stems by cutting off both ends of the jujubes, drilling an opening with a depth of 1-1.2 cm at a center of one of the cutting end surfaces formed, when drilling, keeping a driller vibrating at the same time to core, cutting the cored jujubes into slices of 3-5 mm thickness, classifying the slices, and removing irregular slices;
3) quick-freezing and retaining freshness of the jujube slices by quick-freezing fresh jujube slices at a temperature of −40° C. for 2-5 min, and then retaining at a temperature of −18° C. for standby application;
4) thawing frozen fresh jujube slices by spraying frozen jujube slices from two sides thereof with a steam at a temperature of 110° C. and at a pressure of 0.1-0.15 Mpa, wherein the sprayed steam contains 3-5 wt % of phytic acid, and the steam is sprayed onto a surface of the slices for 1-2 min;
5) protecting color treatment by impregnating thawed jujube slices in color protecting solution for 30-50 min, wherein the color protecting solution is adjusted to pH 8 with NaHCO₃ and contains one or more of zinc gluconate, calcium gluconate, zinc oxide, calcium sulfate, and selenium gluconate;
6) expanding jujube slices under differential pressure by turning on an electromagnetic valve to connect a steam generator and an expansion tank, superheated steam transported by the steam generator heating the expansion tank to raise a temperature in the expansion tank to 102-104° C., and turning off the electromagnetic valve; opening an intake valve to connect an air compressor and the expansion tank, introducing non-condensing gas nitrogen to rise a pressure in the expansion tank from 0.1 MPa to 0.6 MPa in 15-20 min, and closing the intake valve; turning on a vacuum pump and vacuuming a vacuum tank to −0.08 MPa; opening a pressure-relief valve to connect the expansion tank and the vacuum tank, which makes raw materials expanding instantaneously, so that a large amount of water in the expansion tank is taken away; introducing cooling water into cooling tubes quickly to lower a temperature in the expansion tank to 90° C. required for vacuum drying; vacuum drying for 220-250 min, assisting with supersonic during vacuum drying process at a supersonic intensity of 500-800 W, when a moisture content in the raw materials being lower than 5%, closing the pressure-relief valve, and stopping vacuuming; and introducing cooling water to lower the temperature to 25-35° C., opening a ventilating valve, taking out products after the pressure returns to atmospheric pressure;
7) preparing superfine seasoning powder by mixing uniformly 15-25 parts of hawthorn fruit powder, 35-50 parts of cocoa powder, 10-20 parts of cocoa butter, 15-25 parts of coconut powder, and 15-25 parts of jujube powder calculated by total weight, wherein all powders are ultrafine powders with a diameter less than 5-10 μm; and
8) coating of the superfine mixed seasoning powder by spraying the prepared superfine seasoning powder on an outer surface of the expanded jujube slices, and then packaging after completely cooling.

2. The method accoring to claim 1, wherein a method for preparing the hawthorn fruit powder comprises:
pretreating hawthorns by washing the hawthorns, heating and color protecting, beating and sieving, enzymolysis treatment, blending, and spray drying;
first step: adding a compound color protecting agent with total mass fraction of 0.05-0.1% into 20-30 parts of corded and stem-removed hawthorns, and boiling in hot water at a temperature of 80-90° C.;
second step: putting preprocessed hawthorns into a beating machine, beating a mixture containing water and hawthorn with a volume ratio of 1:3, sieving the beaten mixture with a sieve, adding Ca(OH)₂ to adjust pH to 3.5-4.0, and obtaining a hawthorn pulp;
third step: enzymolysis by adding 0.1%-0.2% cellulose complex enzyme, 0.05%-0.1% hawthorn pulp enzyme, 0.1%-0.2% pectinase and 0.10%-0.15% tannase to hydrolyze supersonically the hawthorn pulp obtained in the second step for 3 h at a power of 200-300 W and at a temperature of 50-55° C., and then inactivating enzymes;
fourth step: blending the hawthorn pulp in a blender; and
fifth step: spray drying by putting the hawthorn pulp into a centrifugal spray drying tower, an inlet temperature of the centrifugal spray drying tower being 180-185° C., a flowing rate in a peristaltic pump being controlled at 14 r/min, a rotating speed of a nozzle of the centrifugal spray drying tower being 6400-8000 r/min, after the centrifugal spray drying tower is completely cooled, collecting the produced hawthorn powder for standby application.
